(19) United States
(12) Patent Application Publication
(10) Pub. No.: US 2022/0300894 A1
(43) Pub. Date: Sep. 22, 2022

(54) METHODS AND SYSTEMS FOR OPTIMIZING A LUBRICANTS VALUE CHAIN

(71) Applicant: ExxonMobil Research and Engineering Company, Annandale, NJ (US)

(72) Inventors: Simon A. WATSON, The Woodlands, TX (US); Yu ZHU, Sugar Land, TX (US)

(73) Assignee: ExxonMobil Research and Engineering Company, Annandale, NJ (US)

(21) Appl. No.: 17/692,433

(22) Filed: Mar. 11, 2022

Related U.S. Application Data
(60) Provisional application No. 63/161,697, filed on Mar. 16, 2021.

(51) Int. Cl. G06Q 10/08; G06N 5/04; G06Q 10/06; G06Q 10/04

(52) U.S. Cl. CPC G06Q 10/087; G06N 5/04; G06Q 10/0637; G06Q 10/04

(57) ABSTRACT

A lubricants value chain (LVC) may be managed by a computer-implemented method comprising: providing a plurality of data representative of a LVC and a plurality of hypothetical inputs representative of changes to the data into an isolated data processing environment; converting the plurality of data into one or more scenarios based upon the plurality of hypothetical inputs in the isolated data processing environment; filtering the scenarios based upon one or more properties thereof to create one or more filtered scenarios; processing the filtered scenarios to generate one or more optimized scenarios using a two-stage optimization algorithm in which first and second stages of the optimization algorithm are conducted in sequence and separately from each other, the first stage of the optimization algorithm comprising recipe optimization and the second stage of the optimization algorithm comprising value chain optimization; and determining from the optimized scenarios outputs that optimize profit within the LVC.

### FIELD

The present disclosure relates to methods and systems for managing raw materials and formulated lubricants defining a lubricants value chain and optimizing profit obtained therefrom.

### BACKGROUND

The petroleum industry accounts for a significant share of the world's industrial product markets. In recent years, management of the vast array of products obtained from the petroleum industry has grown increasingly complex as a result of tight competition, strict environmental regulations, low profit margins, and variable demand for and inconsistent availability of petroleum-derived raw materials and formulated products. Consequently, it can be exceedingly difficult for a company to maintain a competitive advantage by managing raw materials and other assets in an optimal manner.

To make informed decisions that satisfy seemingly conflicting multi-objective goals of maximized anticipated profit and simultaneously minimized business risk, strategic planning decisions for managing and optimizing raw materials and formulated products in a value chain continue to be important, particularly in the petroleum industry. Such strategic planning decisions for managing a value chain may be based on historical supply and demand trends, as well as other factors, but the complexity of supply chain and formulation systems may lead to difficulty in optimizing assets in practice. Among the factors that may be taken into account during optimization of a value chain include, for example, expected market demand, source and availability of raw materials, production and distribution costs, incentives, constraints, and the like. Although so-called value chain optimization (VCO) activities have been a growing trend in various industries, many companies have yet to realize a significant economic return due to the number and complexity of the variables involved. In addition, many value chain optimization models may become highly unstable due to the complexity of the analyses. In essence, there are too many interrelated variables to allow simultaneous optimization to take place.

In the petroleum industry, lubricants are a subset of the overall petroleum value chain. A lubricants value chain (LVC) is a function of many complex variables including, for example, recipe flexibility, recipe selection, supply layer allocation incentives and extensive industrial constraints, among others. Typical linear programming models for managing a lubricants value chain may involve the concurrent solution of a plurality of linear equations to find an optimal state for optimizing profit. Unfortunately, simultaneously solving such a large number of equations may lead to model instability due to the number and complexity of the variables characterizing a lubricants value chain. Therefore, there remains a need for more robust methods for LVC management.

### SUMMARY

In various aspects, the present disclosure provides computer-implemented methods for managing a lubricants value chain (LVC). The methods comprise: providing a plurality of data representative of a LVC and a plurality of hypothetical inputs representative of changes to the plurality of data into an isolated data processing environment; converting the plurality of data into one or more scenarios based upon the plurality of hypothetical inputs in the isolated data processing environment; filtering the one or more scenarios based upon one or more properties thereof to create one or more filtered scenarios; processing the one or more filtered scenarios to generate one or more optimized scenarios using a two-stage optimization algorithm in which first and second stages of the two-stage optimization algorithm are conducted in sequence and separately from each other, the first stage of the two-stage optimization algorithm comprising recipe optimization and the second stage of the two-stage optimization algorithm comprising value chain optimization; and determining from the one or more optimized scenarios one or more outputs that optimize profit within the LVC by determining optimal recipe selections for one or more formulated lubricants and supply layer allocations.

Systems and computing devices configured to carry out the foregoing methods are additional aspects of the present disclosure. Computing devices comprise instructions which, when executed by a processor, cause the processor to optimize a lubricants value chain according to the foregoing methods. Systems configured to carry out the foregoing methods comprise a computing device comprising a processor, a memory coupled to the processor, an isolated data processing environment, an optimization engine, and instructions provided to or stored in the memory; wherein the instructions are executable by the processor to optimize a lubricants value chain according to the foregoing methods.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to one having ordinary skill in the art and the benefit of this disclosure.

FIG. 1 is a block diagram of a non-limiting example of process 100 for optimizing a lubricants value chain.

FIG. 2 is a block diagram of a non-limiting example of a two-stage optimization algorithm used in optimizing a lubricants value chain according to the present disclosure.

FIG. 3 is a diagram illustrating a non-limiting example of recipe tier definitions in the form of a tier pyramid.

FIG. 4 is a flow diagram of a non-limiting example of a recipe optimization cascade.

FIG. 5 is a diagram of a supply layer representation within a LVC.

FIG. 6 is a diagram of various categories of LVC optimization and the common timeframes associated with each.

FIG. 7 is an illustrative plot demonstrating how LVCO may be used to determine the optimal component volumes under a range of price scenarios for a specified set of recipes.

FIG. 8 is an illustrative plot of how component costs may by varied across a set of sensitivity analysis cases when optimizing a LVC.

FIG. 9 is an illustrative plot of Monte Carlo case results for the expected LVC value of various new lubricant formulations (Formulations 1-6) in comparison to baseline.

### DETAILED DESCRIPTION

The present disclosure relates to methods and systems for managing raw materials (basestocks, components and premixes of components) and formulated lubricants in a lubricants value chain (LVC), including optimization thereof to increase economic return.

The methods and systems described herein utilize computer-implemented optimization for management of a LVC. The term “lubricants value chain (LVC)” refers to a business organization made up of two or more separate divisions that transfer resources between themselves for the purpose of producing products that are sold to third parties. These products may include basestocks, chemicals, finished lubricants, and additives, among others. Some resources used to produce products in the LVC (e.g., alternative basestocks and other components) may be purchased from third parties.

Choice among multiple basestocks and other components, including compositional range variability in formulated lubricants to afford targeted lubricant properties, may lead to a huge computational problem that may not be easily addressed with existing methods of LVC optimization. Optimal allocation of basestocks and components may include decisions about whether to make or buy a given basestock or component, and/or process a given basestock or component into a formulated lubricant, and/or sell the basestock or component to a third party. Given the number of basestocks and components available in a LVC and the compositional variability thereof, the number of variables involved for determining an optimal solution can easily overwhelm existing LVC models. As described hereinafter, the methods and systems of the present disclosure may determine whether a formulated lubricant or its basestock and components have more economic value within predetermined system constraints and incentives.

LVC optimization according to the present disclosure may utilize a lubricants value chain optimizer (LVCO) in accomplishing the foregoing. Advantageously, one or more scenarios based upon hypothetical inputs into the LVC may be initially processed in an isolated data processing environment and then undergo further filtering before being provided to the LVCO. By processing the scenarios separately, as described further herein, the computational resource burden required for the LVCO may be kept at a manageable level.

The LVCO in the present disclosure may apply a two-stage optimization algorithm: a recipe optimization stage and a value chain optimization stage. The recipe optimization stage may determine optimal recipe selections for formulated lubricants based upon available raw materials (e.g., basestocks and other lubricant components) at a given point in time, which may represent current raw material availability or projected raw material availability in the future and demand therefor. The optimal recipe selections for producing one or more formulated lubricants may be based upon established recipes for the formulated lubricants, wherein the recipes may have flexibility for selection from among a range of basestocks and other components and compositional ranges thereof to provide one or more specified lubricant properties. The value chain optimization stage following the recipe optimization stage in the disclosure herein may then determine the optimal allocation of basestocks and other components for realizing increased, preferably maximized, LVC profit within given system constraints and incentives.

Advantageously, recipe optimization and value chain optimization may take place in sequence and separately from one another in the disclosure herein, thereby defining a staged optimization algorithm. By conducting the two stages of the LVC optimization separately, further enhanced model stability may be realized. Furthermore, the staged optimization algorithm employed herein has significant runtime advantages over a concurrent solution, which otherwise may be required due to the large computational size of the problem. Such attributes allow the LVCO of the present disclosure to be scaled for use in even extremely large problem sets, such as when, for example, thousands of solutions applicable to hundreds or thousands of possible recipes must be reliably solved quickly to manage the LVC effectively. Filtering of scenarios provided to the LVCO for processing in the two-stage optimization algorithm may further mitigate this computational burden.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

The terms “formulation” or “formulated lubricant,” as used herein, refer to a finished product based upon parameters set in a recipe.

The term “recipe,” as used herein, refers to a set of instructions for preparing a particular formulation so that specified lubricant properties are obtained.

The term “treat rate,” as used herein, refers to the actual amount of a component, such as a basestock or other component, incorporated in a formulation prepared based upon a recipe.

The term “scenario,” as used herein, refers to a hypothetical situation created for analysis by the LVCO. To build a scenario, a data set representing resources, incentives, and constraints within a LVC is created, and changes to the initial data set are made based upon hypothetical situations. Multiple scenarios are then provided to the LVCO to determine the optimal state for increasing LVC profit under the chosen hypothetical situations.

The term “basestock,” as used herein, refers to a majority ingredient used to manufacture a formulated lubricant. Basestocks often determine the overall viscometric properties of a formulated lubricant and serve as a carrier fluid for any additives and other minority components.

The term “additive,” as used herein, refers to a minority ingredient used to manufacture a formulated lubricant. Additives are often chemicals that confer specialized properties to a formulated lubricant. The terms “component” and “additive” may be used synonymously herein.

The term “premix,” as used herein, refers to a mixture of ingredients contained in a formulated lubricant that are blended separately from the formulated lubricant itself. Recipes for forming a premix may include other premixes, so several sequential blend steps may be utilized to manufacture some formulated lubricants.

The term “kinematic viscosity (KV),” as used herein, refers to a measure of a fluid's internal resistance to flow under gravitational forces. Kinematic viscosity is determined by measuring the time, in seconds, required for a fixed volume of fluid to flow a known distance by gravity through a capillary within a calibrated viscometer at a closely controlled temperature. Kinematic viscosity typically may be measured at 40° C. and 100° C. as further specified in ASTM standard D445.

The term “cold cranking viscosity (CCS),” as used herein, refers to a measure of lubricant low temperature performance as defined in ASTM standard D5293. CCS typically may be measured at several low temperatures between −5° C. and −30° C.

The term “Noack volatility,” as used herein, refers to a measure of evaporation loss of lubricants in high-temperature service as defined in ASTM standard D5800.

The term “site,” as used herein, refers to a location where formulated lubricant(s), basestock(s) or component(s) are produced, stored, or transferred.

The term “supply layer,” as used herein, refers to the potential economic disposition of a component within a value chain, which may contribute a fixed unit margin or revenue to the value chain. A component volume may be allocated to the supply layer in an optimization solution within predefined volume constraints. Several supply layers may also be defined for a component representing different component dispositions and/or different regions. These supply layers may also be related to each other through component constraints.

The term “mixed integer linear programming,” as used herein, refers to a linear programming problem where an objective function is maximized (or minimized) subject to one or more constraints, where at least one variable can only assume integer values.

The term “sandbox,” as used herein, refers to a data processing platform that allows for the integration of system data and hypothetical inputs, such that scenarios can be created independently before being optimized in a subsequent optimization algorithm. An “isolated data processing environment” may comprise “sandbox” functionality, and these terms may be used synonymously herein. An isolated data processing environment or sandbox represents a testing environment in which data may be manipulated without impacting one or more existing processes from which the data is collected and/or in which the data is utilized. An isolated data processing environment or sandbox in which data manipulation takes place may have communication functionality with other systems, sub-systems, hardware, and/or software, but release of data manipulations within the isolated data processing environment or sandbox are limited to not impacting one or more existing processes unless released to do so by a user.

The term “scenario manager,” as used herein, refers to a computational system or sub-system that manages the automatic creation and optimization of scenarios. A scenario manager may include capabilities to define a range of hypothetical inputs for any number of scenarios and manage the optimization of those scenarios in the LVCO. In doing so, the scenario manager may limit the number of scenarios processed by LVCO at any given time to mitigate computational overload.

The term “tier,” as used herein, refers to a group of recipe options with similar implementation difficulty that may be used to produce products at a given site.

The term “product property claims,” as used herein, refers to attributes of products that are made in a marketing communication. Product property claims may refer to a specification or a performance level that production recipes for that product have been shown to meet.

The terms “division cost” and “transfer price,” as used herein, refer to the cost of a component or formulated lubricant paid by one entity and/or company that is part of a value chain. These costs are often referred to as COGS (Cost of Goods Sold).

The term “LVC cost,” as used herein, refers to the amount paid by a LVC to purchase or manufacture a component or blended product.

The unit “MT,” as used herein, refers to the weight of a component or formulated lubricant given in metric tons.

The terms “computer-readable medium” or “non-transitory, computer-readable medium,” as used herein, refer to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, an EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and/or recognized equivalents thereof, in which the software implementations embodying the present techniques are stored.

LVCO may be used to find opportunities for increasing, preferably maximizing, profit within a LVC. Profit within a LVC is typically a function of many complex variables including recipe flexibility, recipe selection, supply layer allocation, non-linear incentives and extensive constraints, among others. Typical linear programming models involve concurrent solutions of a plurality of linear equations to find the optimal state of a given scenario. When this approach is used to model LVCs, the result is often an unstable value chain model due to the size and complexity of the variable set. The LVCO of the present disclosure uses a staged optimization algorithm, specifically a two-stage optimization algorithm, to achieve model stability and to minimize the solution time, thus reliably generating feasible solutions. Optimization in the LVCO described herein is designed to model actual operational attributes of the LVC. Based on hypothetical input, individual business decisions can be accurately captured in the context of the optimal solution for the entire system. Advantageously, stability may be enhanced with this approach because instabilities in one stage of the optimization process do not propagate through the solution. The optimization problem size is also limited since only a portion of the system is considered at any given time.

Accordingly, the present disclosure provides computer-implemented methods for optimizing a lubricants value chain (LVC). The methods comprise: providing a plurality of data representative of a LVC and a plurality of hypothetical inputs representative of changes to the plurality of data into an isolated data processing environment; converting the plurality of data into one or more scenarios based upon the plurality of hypothetical inputs in the isolated data processing environment; filtering the one or more scenarios based upon one or more properties thereof using the isolated data processing environment to create one or more filtered scenarios; processing the one or more filtered scenarios to generate one or more optimized scenarios using a two-stage optimization algorithm in which first and second stages of the two-stage optimization algorithm are conducted in sequence and separately from each other, the first stage of the two-stage optimization algorithm comprising recipe optimization and the second stage of the two-stage optimization algorithm comprising value chain optimization; and determining from the one or more optimized scenarios one or more outputs that optimize profit within the LVC by determining optimal recipe selections for one or more formulated lubricants and supply layer allocations. The one or more outputs may comprise a production plan for manipulating resources within the LVC. The methods may further comprise producing the one or more formulated lubricants based on a production plan, communicating a production plan to one or more business units, selling the one or more formulated lubricants, or any combination thereof. The foregoing may be further accomplished by converting the characteristics of a lubricants value chain into input data, which may represent resources, incentives and constraints that can be optimized; creating scenarios based upon hypothetical input to be optimized using a platform implemented as an isolated data processing environment; providing a plurality of lubricant characteristics and recipes applicable to lubricant formulations produced in a value chain; and processing one or more scenarios using the two-stage optimization algorithm. The two-stage optimization algorithm may constitute a portion of a LVCO. The first stage of the optimization algorithm may determine the treat rates of components used to blend formulated lubricants, subject to target lubricant properties; optionally select optimal premixes for such recipes; and consider component supply layers during value chain optimization to determine the optimal volume of components produced within the value chain, sold to third parties, and/or used for blending to produce formulated lubricants. Non-linear incentive equations may be incorporated in the two-stage optimization algorithm to account for unit costs and/or unit revenues that vary with volume. Additional features of LVC optimization according to the disclosure herein are provided in further detail below.

The methods and systems described herein may be used to create and analyze a broad range of scenarios based upon hypothetical inputs to data representative of a LVC. Management of a LVC in the disclosure herein may include a LVCO incorporating a two-stage optimization algorithm that can integrate pricing, recipes, component availability, supply layers, formulations, and supply chain and manufacturing constraints to find opportunities for maximizing LVC profit. For any given scenario or range of scenarios, the value chain optimization may leverage formulation and supply flexibility to find an optimal solution for increasing profit. Output from the LVCO may include optimized formulation recommendations, basestock/chemicals supply layers and profit. As non-limiting examples, the output may provide recommendations as to whether to make or buy a given basestock and/or whether a basestock should be sold or processed into a formulated lubricant in order to maximize profit.

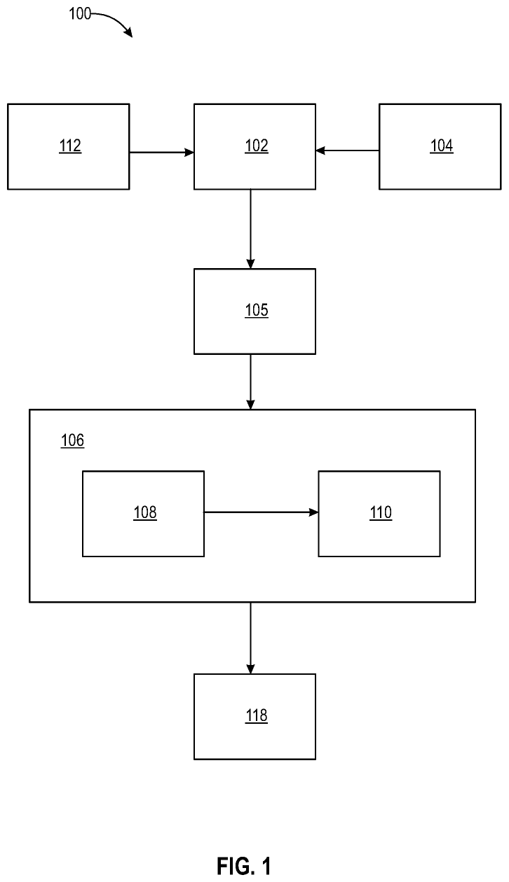

FIG. 1 is a block diagram of a non-limiting example of process 100 for optimizing a lubricants value chain. Data 112 representing characteristics such as resources, incentives and constraints within a lubricants value chain is provided to isolated data processing environment 102, which may include “sandbox” functionality. Data 112 may include features such as supply layers, component availability, production plans, current recipes, developmental recipes, component prices and properties, constraints and incentives, basestock price curves the like, and any combination thereof. Isolated data processing environment 102 may include one or more databases, functionality for accessing business unit data, the like or any combination thereof. Within isolated data processing environment 102, data 112 is converted into one or more scenarios by integrating hypothetical inputs 104, which are also provided to isolated data processing environment 102. Hypothetical inputs 104 represent changes to data 112 that are utilized to generate multiple scenarios for further optimization. The multiple scenarios are subsequently provided to LVCO 106 and processed further, as described hereinbelow.

Microsoft Excel or another data processing environment represent suitable examples of isolated data processing environment 102 that may be used in the disclosure herein to create one or more scenarios by combining data 112 and hypothetical inputs 104. A plurality of scenarios may be created, each based upon different hypothetical inputs 104. Properties of the scenarios may be analyzed in isolated data processing environment 102 and/or downstream therefrom in scenario manager 105. Scenario manager 105 is a software sub-system that may manage the transfer of the scenarios from isolated data processing environment 102 to LVCO 106, including filtering and executing the scenarios. Scenario manager 105 may provide dynamic control and optimization of one or more jobs in LVCO 106 in such a way that computational resources are efficiently used and without exhausting available computing capacity. In non-limiting examples, filtered scenarios may focus upon a subset of possible formulated lubricants and at one or more specified times.

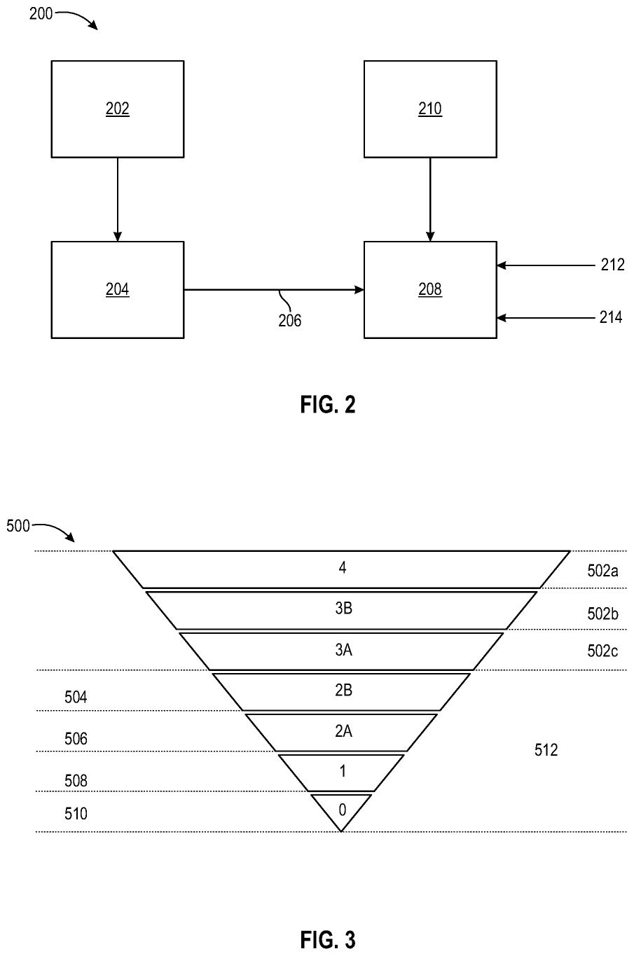

LVCO 106 features a two-stage optimization algorithm, wherein the two stages are conducted in sequence and separately: recipe optimization stage 108 and value chain optimization stage 110. Although not illustrated in FIG. 1, additional inputs like constraints, incentives, the like, and any combination thereof may be considered when optimizing LVCO 106. FIG. 2, discussed in further detail below, provides a more complete description of the two-stage optimization algorithm within LVCO 106 and the inputs thereto. Briefly, recipe optimization stage 108 may provide the relationship between components and amounts thereof in a formulated lubricant, as specified by a recipe, and the lubricant properties resulting therefrom. Lubricant properties that may be targeted in formulated lubricants and modelled in the present disclosure may individually be represented by specific values, ranges of values, threshold values, and the like. Examples of desired lubricant properties for formulated lubricants may include, but are not limited to, kinematic viscosity (Kv₄₀ and Kv₁₀₀), cold cranking viscosity, Noack volatility, the like and any combination thereof. Recipe optimization stage 108 may process the scenarios received from scenario manager 105 to determine recommendations for formulated lubricants and further execute the value chain model within value chain optimization stage 110. Among other functions, value chain optimization stage 110 may analyze the economic value of each formulated lubricant, non-formulated lubricant components, and the amount of each formulated lubricant produced or available at a given point in time, again based upon the scenarios received from scenario manager 105. Briefly, during recipe optimization stage 108, a cascade of optimization runs determine optimal component selections and treat rates for every possible recipe for producing a given set of formulated lubricants. The resulting recipes may also be categorized by implementation effort (i.e., in tiers), as discussed below in reference to FIG. 3. During value chain optimization stage 110, LVC profit may be increased by determining optimal recipe selections and supply layer allocations while considering incentives and constraints. The characteristics of the recipes included in value chain optimization stage 110 are loaded from the solution of recipe optimization stage 108. Recipe tiers and product property claim filters may be included in the data stream to allow a user to select which recipes are included in value chain optimization stage 110.

Output 118 provides the result for optimizing profit within the LVC in view of the scenarios created in isolated data processing environment 102 and further analyzed in LVCO 106 in view of additional constraints and incentives. In non-limiting examples, output 118 may include a proposed production plan listing treat rates for producing a specific set of lubricants; make, buy and/or sell decisions for basestocks and components; amounts of each formulated lubricant to be made, and any combination thereof, as well as related data. Such related data may include, but is not limited to, value chain analysis, revenue projections (profit), basestock supply layers, implementation instructions for producing optimized formulation recommendations, the like, and any combination thereof. When output 118 includes more than one optimized formulation recommendation, the related data may be useful to an operator when deciding which optimized formulation recommendation(s) to implement. The optimal solution (i.e., the results) of the filtered scenarios resulting in output 118 may provide an optimal implementation process and/or decision support. As non-limiting examples, output 118 may be displayed on a dashboard for an operator to view and act upon, be communicated to one or more implementation modules (e.g., the production process or placement in a queue thereof), be communicated to customer support (e.g., as an alternative and/or improvement to an existing product), the like, and any combination thereof.

FIG. 2 is a block diagram of a non-limiting example of a two-stage optimization algorithm used in optimizing a lubricants value chain according to the present disclosure. The two-stage optimization algorithm depicted in FIG. 2 represents a more detailed view of the two-stage optimization algorithm utilized in LVCO 106 and discussed in reference to FIG. 1 above. In FIG. 2, two-stage optimization algorithm 200 applicable to a LVC includes two main process steps: recipe optimization 204 and value chain optimization 208. During recipe optimization 204, optimization inputs 202, comprising, for example, recipes, component costs, and/or active recipes, as well as scenarios based thereupon, can be processed to determine optimal component selections and treat rates for a plurality of possible recipes potentially slated for production. Possible recipes for production may include a choice of various lubricant components and a compositional range thereof to achieve one or more desired lubricant properties (e.g., kinematic viscosity, cold cranking viscosity, Noack volatility, or the like) in a specified set of formulated lubricants. The resulting recipes can be categorized by implementation effort (e.g., in tiers) 206, as further illustrated in FIG. 3 and discussed below. During value chain optimization 208, LVC profit can be increased, with a maximum increase being preferred, by determining optimal recipe selections, including specified treat rates, and supply layer allocations 210, while also considering incentives 212 and constraints 214. The desired recipe flexibility can be controlled by filtering the recipes and scenarios based thereupon that are passed into value chain optimization 208.

Non-limiting example of incentives 212 and constraints 214 that may be evaluated in optimizing a lubricants value chain according to the present disclosure are shown in Tables 1 and 2 below, respectively. It is to be appreciated that other types of incentives 212 and constraints 214 may be considered, and the listed incentives 212 and constraints 214 should not be considered limiting of the scope of the present disclosure. Additional discussion regarding incentives 212 and constraints 214 is provided below.

TABLE 1

| Type | Incentive | Description |
|---|---|---|
| Component | Global Component Sum | Division collects incentive |
| Volume Sum | Incentive | on the volume of several |
| | | defined components. |
| | | Incentive calculated as |
| | | [Volume |
| | | Incentive]*[Volume] + |
| | | [Fixed Incentive] |
| Volume | Global Component Sum | Division collects incentive if |
| Equation | Incentive | total global volume of |
| | Minimum/Maximum | several defined components |
| | | is between minimum and |
| | | maximum volumes. |
| | | Incentive calculated as |
| | | [Volume |
| | | Incentive]*[Volume] + |
| | | [Fixed Incentive] |
| Component | Site Component Sum | Division collects incentive |
| Volume Sum | Incentive | on total volume of several |
| | | defined components at |
| | | different sites. Incentive |
| | | calculated as [Volume |
| | | Incentive]*[Volume] + |
| | | [Fixed Incentive] |
| Volume | Site Component Sum | Division collects incentive if |
| Equation | Incentive | total volume of several |
| | Minimum/Maximum | defined components at |
| | | different sites is between |
| | | minimum and maximum |
| | | volumes. Incentive |
| | | calculated as [Volume |
| | | Incentive]*[Volume] + |
| | | [Fixed Incentive] |
| Recipe | Recipe Incentive | Division collects incentive if |
| | | the specified recipes are |
| | | selected in the solution. Use |
| | | filter inputs to specify |
| | | applicable recipes. Incentive |
| | | can be applied to recipes at |
| | | the site and product level. |
| | | Multiple recipes incentives |
| | | in input are additive. |

TABLE 2

| Type | Constraint | Description |
|---|---|---|
| Component Volume | Global | Restricts total global amount of a |
| | Component | component |
| | Constraint | |
| Component Volume | Site | Restricts total amount of a component |
| | Component | at a site |
| | Constraint | |
| Minimize/Maximize | Global | Minimize the total global volume of a |
| Component Volume | Component | list of component(s) |
| | Minimize | |
| Minimize/Maximize | Global | Maximize the total global volume of a |
| Component Volume | Component | list of component(s) |
| | Maximize | |
| Minimize/Maximize | Site | Minimize total volume of a list of |
| Component Volume | Component | component(s) at different site(s) |
| | Minimize | |
| Minimize/Maximize | Site | Maximize total amount of a list of |
| Component Volume | Component | component(s) at different site(s) |
| | Maximize | |
| Component Volume | Global | Global SumProduct[component(s), |
| Equation | Component | multiplication factors)] > {Global |
| | Equation | SumProduct[component(s), |
| | | multiplication factor(s)] + offset |
| | | [MT]} |
| | | or |
| | | Global SumProduct[component(s), |
| | | multiplication factors)] < {Global |
| | | SumProduct[component(s), |
| | | multiplication factor(s)] + offset |
| | | [MT]} |
| Component Volume | Site | Site SumProduct[component(s), |
| Equation | Component | multiplication factors)] > {Site |
| | Equation | SumProduct[component(s), |
| | | multiplication factor(s)] + offset |
| | | [MT]} |
| | | or |
| | | Site SumProduct[component(s), |
| | | multiplication factors)] < {Site |
| | | SumProduct[component(s), |
| | | multiplication factor(s)] + offset |
| | | [MT]} |
| Tier 3 Component | Tier 3 | Globally restrict a component so it is |
| Restriction | Global | not selected for inclusion in any Tier 3 |
| | Component | recipe |
| | Constraint | |
| Tier 3 Component | Tier 3 | Restrict a component so it is not |
| Restriction | MBU | selected for inclusion in any Tier 3 |
| | Component | recipe within an MBU |
| | Constraint | |
| Type | Constraint | Description |
| Tier 3 Component | Tier 3 Site | Restrict a component so it is not |
| Restriction | Component | selected for inclusion in any Tier 3 |
| | Constraint | recipe within a site |
| Site Capacity | Site | Assigns a fixed unit of capacity at a |
| | Component | site |
| | Capacity | |

Recipes undergoing optimization may be further categorized into tiers. FIG. 3 is a diagram illustrating a non-limiting example of recipe tier definitions in the form of tier pyramid 500. Tiers in tier pyramid 500 may be considered by a user to designate which recipes may pass into the value chain optimization stage of the two-stage optimization algorithm. For example, tier definitions may allow a user to select the degree of implementation difficulty in the solution of a LVCO, for example. Filtering in the two-stage optimization algorithm may take place such that only recipes having a maximum tier difficulty are considered. In tier pyramid 500, all components for tiers 0, 1, 2A, and 2B, are available at site 512. Tier 0 refers to an “active recipe tier” 510, tier 1 refers to a “current brand approval tier” 508, tier 2A refers to a “withdrawing brand approval tier” 506, and tier 2B refers to a “no brand approval tier” 504. Other recipes are defined within partial or no site availability parameters 502a, 502b and 502c, with respect to one or more components used in producing a formulated lubricant. Tier 3A refers to recipes in which “some component(s) are unavailable at site, but are used at another site tier” 502c. Tier 3B refers to recipes in which “some component(s) are unavailable at site, and only are as a global (supplier) component, i.e., a purchased component tier” 502b. Tier 4 refers to recipes in which “some component(s) are unavailable in network tier” 502a. The increasing tier pyramid width in progressing from tier 0 through tier 4 represents increasing implementation difficulty in producing a recipe. The pyramid width at a given tier also may be representative of the number of recipes in the tier. In typical LVCO scenarios, only a subset of recipes are designated in lower tiers at each production site.

The two-stage optimization algorithm may define a linear programming model and/or utilize a first type of mathematical model and a second type of mathematical model, which are different from one another and may be used in sequence. In at least one embodiment, the first type of mathematical model may be a treat rate optimization model, and the second type of mathematical model may be a LVC model. The first type of mathematical model and the second type of mathematical model may be developed as mixed integer linear programming problems. The first type of mathematical model and the second type of mathematical model may be written using optimization software (e.g., AIMMS™ platform) and solved by a mathematical programming solver (e.g., CPLEX™ solver).

As described above, LVCO of the present disclosure may employ a two-stage optimization algorithm to achieve value chain model stability, limit the solution time and reliably generate feasible solutions. Preferably, LVCO may include linked optimization processes that occur separately at different times, rather than as one concurrent optimization process. Each optimization process and the relationships therebetween may model actual operational attributes of a LVC. Based on hypothetical input, for example, individual business decisions can be accurately captured in the content of the optimal solution for the entire system (lubricant characteristics and available recipes, within additional incentives and constraints). Stability can be enhanced with the methods and systems of the present disclosure because instabilities in one stage of the optimization process cannot propagate through the solution and impact the next stage.

Value can be captured from a LVC by optimizing the recipes used to blend products (formulated lubricants). Accordingly, the recipe optimization stage employed during LVCO determines the optimal treat rate of components in recipes, while accounting for component selection and availability, minimum and maximum treat rate of components, premix selection and implementation characteristics. Specialized algorithms may solve for optimized recipes for producing one or more formulated lubricants, while accounting for the complexity and computational size of the problem.

Advantageously, lubricant properties may vary as linear or log-linear combinations of contributions from one or more components comprising the lubricants. LVCO may model the lubricant properties achievable with a specific recipe using a linear or log-linear property model. Optimal treat rates may be determined by minimizing blending cost subject to treat rate and component property constraints. During the optimization, several target lubricant properties may be considered including: kinematic viscosities at 40° C. and 100° C.; cold cranking viscosities at −5° C., −10° C., −15° C., −20° C., −25° C., −30° C., and −35° C.; and Noack volatility, among others. The final solution for a recipe may have blended properties within limits set in the scenario determined in the isolated data processing environment. Binary variables may be employed in the two-stage optimization algorithm to allow for the substitution of components in recipes based on component availability, property effects and cost.

In accomplishing the foregoing, the methods of the present disclosure may determine a bias calculated for each property of the formulated lubricants subject to Equation 1. A bias can be incorporated in property constraints so the resulting optimal treat rates and blended properties accurately represent those of actual formulated lubricants obtained during production.

$$ln ( B i a {s}_{i} ) = ln {v}_{i} - {\sum }_{j} ( ln {u}_{j} ) {w}_{j} \qquad ( Equation 1 )$$

wherein,
Biasᵢ is bias calculated for property i
vᵢ is a blended recipe calibration value for property i
wⱼ is a calibration weight percent of component j in a calibration blend
uⱼ is a neat property value for component j.
   Thus, in at least one embodiment, bias may be incorporated to compensate for any unexpected non-linearity in the model.

Processing of one or more filtered scenarios may leverage a calibration blend to estimate the impact of components for which no property data is available. Methods of the present disclosure may further comprise producing the calibration blend and/or analyzing the calibration blend.

There are currently no compositional models for lubricants that fully determine physical properties based on the properties of individual lubricant components and their contribution to the properties of a resulting formulated lubricant. In response, the LVCO of the present disclosure can leverage a calibration blend to estimate the properties of a formulated lubricant, particularly when the formulated lubricant contains a component for which the impacts are substantially unknown and/or no property data is available. The basic process is to make a calibration blend, which is a lubricant comprising basestocks (BS) and viscosity modifiers (VM) or similar components with known properties for kinematic viscosities at 40° C. and 100° C., Noack volatility, and/or CCS, among others. For the properties that exhibit log-linear behavior, the property values can be converted into log space before proceeding further. The calibration blend may then be used to calculate a bias term by applying Equation 2 below. If the component has a range for its weights, then it may be used to provide actual property values for the bias calculation. The constant term in Equation 2 provides a bias contribution for the components whose weight cannot change.

$${bias}_{property} = {Product}_{Property}^{Typical} - {\sum }_{c} {Component}_{Property}^{Actual} * Weight {\%}^{Typical} \qquad ( Equation 2 )$$

After the bias is calculated, future blends defining a formulated lubricant may have their properties estimated with Equation 3:

$${Product}_{Property}^{Estimated} = {bias}_{property} + {\sum }_{c} {Component}_{Property}^{Actual} * Weight {\%}^{optimized} \qquad ( Equation 3 )$$

wherein, in Equations 2 and 3:
Weight %^{Optimized} and Product_{Property}^{Estimated} are variables determined by treat rate optimization, Product_{Preperty}^{Typical}, Component_{Property}^{Actual} and Weight %^{Typical} are original known parameters downloaded from a recipe database or determined in practice, and bias_{property} are calculated parameters.

Formulated lubricants may be blended in a staged process, wherein components can be combined as premixes prior to being incorporated together to form an actual formulated lubricant. Premixes may further be a blend comprising one or more premixes, each having their own recipes and properties thereof, which results in products being composed of many related recipes and recipe layers. That is, a formulated lubricant may be obtained by blending a premix with additional components, blending two or more premixes together, and/or blending two or more premixes together with additional components. Each premix used in producing a formulated lubricant may be blended with different recipe options. Complex premix options inherent to the LVC, or other blending systems, may be modelled using the recipe optimization stage implemented in LVCO according to the present disclosure. Optimal premix options can be selected for recipes after every step in the recipe optimization, which may define a recipe optimization cascade.

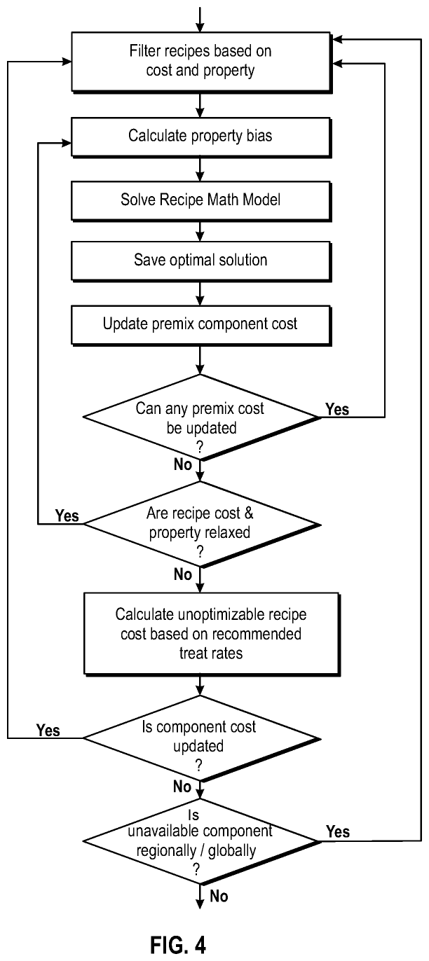

LVCO optimization may incorporate a recipe optimization cascade when processing one or more filtered scenarios. FIG. 4 is a flow diagram of a non-limiting example of a recipe optimization cascade. As described above, lubricant recipes may feature several types of optionality that cannot be modelled successfully with typical optimization techniques, but may be modelled through application of the disclosure herein, namely by accounting for premix and component flexibility. The two-stage optimization algorithm in the present disclosure may incorporate logical checks that manipulate available flexibility within a recipe. The recipe optimization cascade depicted in FIG. 4 cycles recipes through the flow diagram until the most optimal formulation options are identified in the solution. This approach minimizes the number of options considered during each optimization process, which may improve the stability of the value chain model and reduce the solution time. Methods incorporating a recipe optimization cascade may include: filtering recipes based on cost and property to obtain filtered recipes with defined properties; create one or more scenarios from the recipes and filtering the scenarios; calculating property bias for each property obtained from recipes within one or more scenarios; solving a recipe mathematical model to obtain an optimal solution based upon one or more scenarios; saving the optimal solution based upon the one or more scenarios; updating premix component cost; determining if any premix cost can be updated; determining if recipe cost and property are relaxed; calculating any unoptimizable recipe cost based on recommended treat rates; determining if the component cost is updated; and processing any unavailable components to determine if there is any regional or global availability. Optimal premix options can be selected for recipes after each decision in the recipe optimization cascade.

In more particular examples, processing one or more filtered scenarios during the two-stage optimization algorithm may comprise: solving the one or more scenarios using one or more mathematical models; saving an optimal solution for the one or more scenarios; calculating a recipe cost based on the one or more optimized treat rates; calculating a bias for each property during recipe optimization; updating a premix component cost during recipe optimization; and estimating costs for any unavailable components.

The structure of the recipe optimization cascade shown in FIG. 4 allows for the categorization of recipes based on the implementation difficulty level at different production sites. As such, the two-stage optimization algorithm may group recipes into site-specific implementation difficulty tiers based on the availability of components in the recipe and the configuration of assets at the site to make the recipe (often captured by a site brand approval). Additional details regarding the grouping of recipes into tiers is provided in FIG. 3.

A premix selection algorithm can provide a realistic representation of LVC production requirements while limiting memory requirements for processing the value chain model. Binary variables and custom production constraints can be used to implement this functionality. During optimization of the value chain model, a table of binary variables can be created, indicating which premix recipes can be required to blend each recipe passed into the value chain optimization stage of the model. These recipes may include only those that contain premix tiers defined by a user, for example. During a linear programming solution, a constraint may be imposed using the data in the table that allows one premix recipe to be selected per blending site or a small set of selected premixes.

A recipe optimization cascade suitable for use in the present disclosure may be modified to fully account for all recipe options created by premix optionality. Rather than select the most cost optimal premixes, a list of all possible recipes may be created based on the allowed premix flexibility. Optimal recipes may be selected from this list during optimization of the LVC. A constraint may be included to ensure that one premix recipe (or a small set of premix recipes) is selected for each premix produced at each site.

During the recipe optimization stage of the two-stage optimization algorithm, component costs may be loaded as division or LVC costs, as specified by the user. When division costs are used in recipe optimization, the resulting formulated lubricants and amounts thereof may be optimized to deliver the highest value to the division, or part of the LVC, that blends the formulated lubricant. Optimizing with LVC costs increases the value to the entire LVC.

The second stage of the two-stage optimization algorithm, value chain optimization, determines the optimal allocation of basestocks and other components resulting in a specified amount of profit, preferably maximum profit, with given system constraints. The value chain optimization stage of the two-stage optimization algorithm can execute customer demands with the lowest cost to the LVC by determining the optimal formulated lubricants based upon available recipe selections and allocation of basestocks and other components to third party customers.

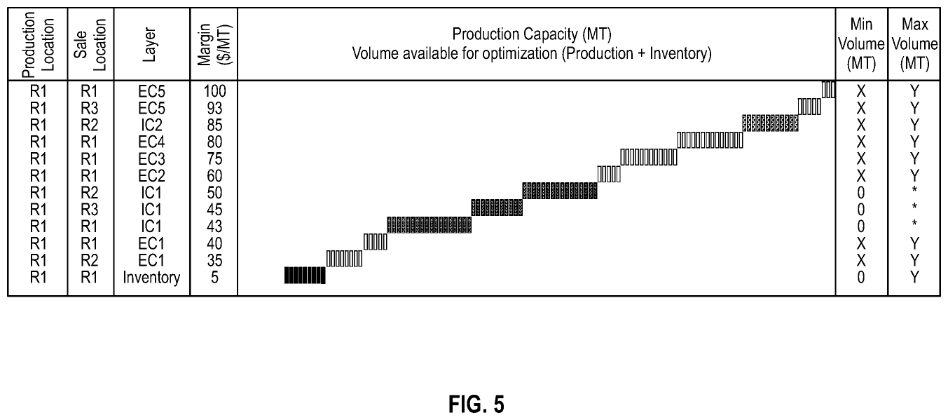

Supply layers may be used to represent options for the allocation of components to third parties or internally within the LVC. FIG. 5 shows a diagram of a supply layer representation within a LVC. In this example, basestock is produced in one region (R1), where the production capacity is fixed over the period of time modelled in the case. The available production capacity may be sold into several different regional layers of customer demand, inventory, or production optionality. Sales may take place in the region where production takes place (R1) or in different regions (R2 and R3). Each layer yields a set margin to the LVC and is constrained by set minimum and maximum volumes that may be sold to the layer. The solution of value chain optimization will be an allocation of the entirety of the available volume to each layer that maximizes profit while remaining within the set constraints. The supply layer model may be linked to the recipes used to produce formulated lubricants by defining specific layers for the consumption of basestock within the LVC. In this example, these layers are defined as internal customers (IC) and are assigned to sales regions that correspond to the location of the formulated lubricant. Supply layers allocated for external customers (EC) are also noted, wherein the geographical location of external customers is not necessarily limited by the production location. The recipes selected by the two-stage optimization algorithm in a production plan may regulate the amount of basestock allocated to the IC layers in the solution. The minimum volume of basestock remaining in inventory may be specified as zero or non-zero (zero inventory allowed in this example), and the maximum value may be specified at a desired threshold. Similarly, supply layers may require a zero or non-zero minimum volume of allocated basestock.

Supply layers may be modeled as a set of linear equations and constraints that may be solved simultaneously to find the optimal solution. The solution can maximize (i.e., increase) LVC profit represented by the following simplified objective function (Equation 4):

$$LVC Total Profit = {\sum }_{i} {FLProductionProfit}_{i} + {\sum }_{j} {SupplyLayerProfit}_{j} + {\sum }_{k} {SiteIncentiveProfit}_{k} + {\sum }_{l} {GlobalIncentiveProfit}_{l} \qquad ( Equation 4 )$$

wherein
FLProductionProfitᵢ Profit for each product produced by the Finished Lubricants division
SupplyLayerProfitⱼ Profit for each layer in supply layer model
SiteIncentiveProfitₖ Profit for each included incentive on a site level
GlobalIncentiveProfitₗ Profit for each included incentive at a global level

The representation of the basestocks and components within a chemicals business as a collation of supply layers can be a suitable aspect of LVCO. This approach is an efficient representation of the relationship between formulation selections and the allocation of equity basestocks, such that LVC profit can be maximized across many types of input cases.

The solution to value chain optimization can be determined subject to many types of constraints, such as the illustrative constraints shown in Table 2 above. Component volume constraints may restrict the amount of one or many components in the LVC, or at a location in the LVC, as shown in the exemplary supply layer shown in FIG. 5. The volume of component(s) may be minimized or maximized in the solution using maximum/minimize volume constraints. Volume equation constraints may be used to create custom constraints, which may be used to model contracts, blending limitations and other complex LVC constraints. Site capacity constraints may be used to model blend plant tankage and other blending constraints. Finally, Tier 3 component constraints may be used to control the availability of components at various sites.

The solution to value chain optimization may also be determined subject to many types of incentives, such as the illustrative incentives shown in Table 1 above. The purpose of incentives is to modify the economics associated with various alternatives in the solution. Incentives may modify the total profit function optimized during the LVC optimization stage. Component sum incentives add credits, or debits, proportional to the sum of component volumes. Piecewise linear credits may be added to the profit function by including volume equation incentives. Finally, recipe incentives may be added to include recipe switching costs, or thresholds for recipe switches in the solution.

Of the many incentive types in LVCO, two incentive types may particularly enhance the ability to accurately model a LVC: component incentive equations with minimum and/or maximum limits, and recipe incentives. Component incentive equations add incremental economics associated with the use of different components in the LVC. These incentives may be implemented with user defined fixed and variable components, across a defined range. This flexible definition allows a user to approximate non-linear dependences in the LVC optimization as an objective function. A component incentive equation may have the following structure (Equation 5):

$$if {v}_{min} \leq {\sum }_{l} {v}_{c , l} \leq {v}_{max} {Incentive}_{i , D} = {\sum }_{j , k} {f}_{j , k} {v}_{j , k} {VolumeIncentive}_{j , k} + {FixedIncentive}_{i} \qquad ( Equation 5 )$$

wherein,
Incentive_{i,D} Value of incentive attributed to division D [$]
f_{j,k} Input multiplication factor associated with component j at site k
v_{j,k} Volume of component j at site k [MT]
Volumelnventive_{j,k} Volume incentive for component j at site k [$/MT]
FixedIncentiveᵢ Fixed incentive [$]
v_{c,l} Volume of component c in solution [MT]
vₘᵢₙ Minimum volume threshold to activate incentive [MT]
vₘₐₓ Maximum volume threshold to activate incentive [MT]

The use of volume thresholds in the above incentive definition allows for the inclusion of piecewise discontinuous functions for modelling a LVC. This feature may be used to layer complex elements into LVC models such as tranche pricing, freight costs constrained by capacity and specialty agreement provisions, among others.

Recipe incentives may also be utilized when optimizing a LVC according to the present disclosure. Binary variables may be used to associate incentive values with recipes selected in a solution. These values may be proportional to the production volume of the recipe, or a fixed value when the recipe is active. Among other uses, recipe incentives may be used to dampen the value chain optimization solution by assigning thresholds that must be achieved before a recipe switch occurs. This is feature of the LVC model addresses a common criticism of other linear programming models, which are often known to ignore the costs associated with changes suggested in solutions.

The data modelling a LVC can be updated frequently to ensure that the LVCO is a current representation of the LVC. Baseline data may be updated whenever new data becomes available.

Standalone third party models can also be analyzed using LVC optimization according to the present disclosure. That is, LVC may be offered as a service to non-aligned third parties rather than being utilized for optimizing an internal LVC only. Third party use case modelling may represent new revenue streams for a company. Accordingly, methods of the present disclosure may further comprise: providing LVC or formulation optimization as a service to basestock customers; identifying opportunities for increased sales of basestocks to customers (through incentives or formulation switches); providing insights on a basestock customers demand elasticity; and assessment of mergers and acquisitions to find synergies.

It is to be appreciated that the methods and systems described herein are implemented, at least in part, using computing devices or processor-based devices that include a processor; a memory coupled to the processor; and instructions provided to the memory, wherein the instructions are executable by the processor to perform the methods described herein (such computing or processor-based devices may be referred to generally by the shorthand “computer”). For example, a system may comprise: a processor; a memory coupled to the processor; and instructions provided to the memory, wherein the instructions are executable by the processor for optimizing a LVC according to the disclosure herein. An optimization engine may be incorporated as well, which may be cloud-based in some configurations. Local optimization engines may be utilized as an alternative in some cases.

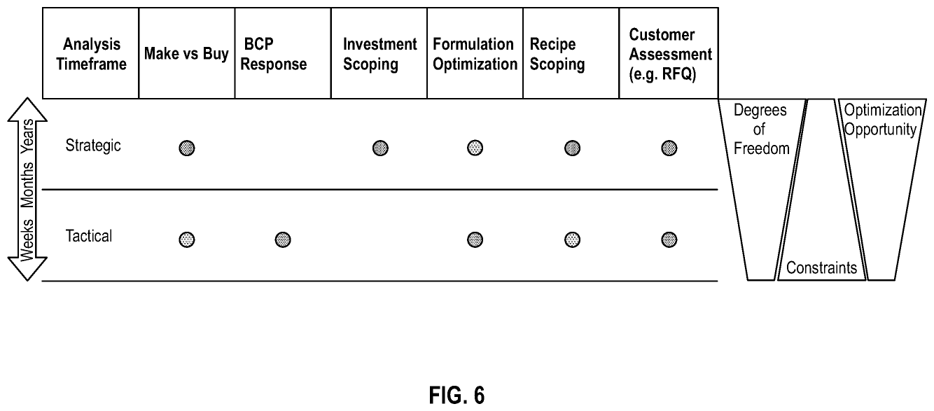

The LVC optimization may be employed to seek optimal responses to various types of LVC supply scenarios based upon one or more applications. Such optimization may be employed strategically or tactically by specifying scenario input in accordance with the timeframe being modelled. Example applications of LVC optimization and their corresponding analysis timeframes are shown in FIG. 6. Some applications of LVC optimization forming the basis for scenarios that may be resolved in accordance with the foregoing include, for example:
Make versus buy decisions;
Short or long component availability;
Business continuity planning (BCP) response (recipe and production changes);
Investment scoping;
Formulation selection;
Development formulation scoping (assess impact of development formulations);
Formulation flexibility assessment;
Recipe optimization (use of best formulation based on LVC value);
Production scoping;
Request for quote (RFQ) analysis;
Customer profitability;
Procurement planning, contract scoping and cost changes;
Break even analysis;
Parametric studies and sensitivity analysis;
Monte Carlo simulation (price, volume, parameter uncertainty, etc.).

FIG. 6 is a diagram showing the effect of analysis timescale on degrees of freedom, constraints and optimization opportunity for some example use cases when optimizing a LVC. LVC optimization can analyze any scenario type within tactical or strategic timeframes. FIG. 6 indicates how some example use cases may be modelled in such a manner. The analysis timeframe of a case can be varied by changing the input data and constraints used to produce various scenarios. Tactical analysis can be often performed with current data from systems and may involve more constraints because it is often difficult to make changes to a supply chain within a short period of time. Strategic analyses, in contrast, may employ forecasted input representing a future state and may have fewer constraints. During strategic analyses, the value of optimization opportunities are often higher compared to the value of optimization opportunities obtained by tactical analysis, particularly due to the significant degrees of freedom of the strategic analyses.

Algorithms for optimizing a LVC in accordance with the present disclosure may be carried out locally on a user's computer or be accessed through an intranet or internet platform (e.g., a cloud-based server). The platform can be accessed by any user on a defined network, potentially subjected to access controls or a subscription. It may also be made accessible to users over a web browser. In at least one embodiment, LVC optimization may be designed to be available for ad-hoc modelling.

To start an analysis according to the present disclosure, a user may download a baseline model that is the combination of data applicable to a LVC. Different scenarios can be created by changing these values manually in the baseline or through the isolated data processing environment (e.g., through processing in a sandbox based on hypothetical input). To run a case, input data in the form of processed scenarios may be provided to a LVCO. A scenario manager can be used to automatically load a plurality of scenarios into the LVCO when many runs are needed to analyze a range of scenarios (e.g., parametric studies, and Monte Carlo simulation).

Data may be input directly from live systems whenever possible. The use of data from primary-source systems is encouraged to ensure that baseline data is consistent and representative of the LVC. A supply layer input may be collected from a Supply Optimization Advisor (SOA) in the basestocks and chemicals. The supply input may be built directly from source databases without manual manipulation.

Optimized solutions of provided scenarios can be explored through a graphical user interface. A user may also download the results into text files or produce graphical output. As non-limiting examples, output data may include optimized formulation recommendations, production plan, supply layer volumes, expected profit, and any combination thereof.

Embodiments disclosed herein include:

A. Computer-implemented methods for optimizing or managing a lubricants value chain. The methods comprise: providing a plurality of data representative of a LVC and a plurality of hypothetical inputs representative of changes to the plurality of data into an isolated data processing environment; converting the plurality of data into one or more scenarios based upon the plurality of hypothetical inputs in the isolated data processing environment; filtering the one or more scenarios based upon one or more properties thereof to create one or more filtered scenarios; processing the one or more filtered scenarios to generate one or more optimized scenarios using a two-stage optimization algorithm in which first and second stages of the two-stage optimization algorithm are conducted in sequence and separately from each other, the first stage of the two-stage optimization algorithm comprising recipe optimization and the second stage of the two-stage optimization algorithm comprising value chain optimization; and determining from the one or more optimized scenarios one or more outputs that optimize profit within the LVC by determining optimal recipe selections for one or more formulated lubricants and supply layer allocations. Optionally, the methods may further comprise one or more of: producing the one or more formulated lubricants based on a production plan, communicating a production plan to one or more business units, selling the one or more formulated lubricants, or any combination thereof.

B. Systems configured for optimizing or managing a lubricants value chain. The systems comprise: a computing device comprising: a processor; a memory coupled to the processor; an isolated data processing environment; an optimization engine; and instructions provided to or stored in the memory, wherein the instructions are executable by the processor to optimize a lubricants value chain according to A.

C. Computing devices configured for optimizing a lubricants value chain. The computing devices comprise instructions which, when executed by a processor, cause the processor to optimize a lubricants value chain according to A.

Each of embodiments A-C may have one or more of the following additional elements in any combination:

Element 1: wherein the plurality of data includes a plurality of lubricant characteristics and recipes applicable to a plurality of formulated lubricants.

Element 2: wherein the one or more scenarios are based upon one or more applications selected from the group consisting of treat rates; make versus buy; short and/or long component availability; supply layers; Business Continuity Planning (BCP) response including recipe and production changes; investment scoping; development formulation scoping including assessed impact of development formulations; formulation flexibility assessment; recipe optimization; incentives; constraints; production plan; component properties; production scoping; production planning; Request for Quotation (RFQ) analysis; customer profitability; procurement planning and supplier negotiations; break even analysis; hypothetical inputs; parametric studies and sensitivity analysis; Monte Carlo simulation including price, volume, and parameter uncertainty; and any combination thereof.

Element 3: wherein recipe optimization applies one or more of the following parameters to a recipe: component selection and availability, treat rate flexibility comprising minimum and maximum treat rates, premix selection, and implementation characteristics.

Element 4: wherein processing the one or more filtered scenarios comprises: solving the one or more scenarios using one or more mathematical models; saving an optimal solution for the one or more scenarios; calculating a recipe cost based on one or more optimized treat rates; calculating a bias for each property during recipe optimization; updating a premix component cost during recipe optimization; and estimating costs for any unavailable components.

Element 5: wherein the two-stage optimization algorithm defines a linear programming model.

Element 6: wherein the two-stage optimization algorithm comprises a first type of mathematical model and a second type of mathematical model.

Element 7: wherein the first type of mathematical model and the second type of mathematical model are developed as mixed integer linear programming problems.

Element 8: wherein recipe optimization includes at least treat rate optimization.

Element 9: wherein the two-stage optimization algorithm determines one or more specific formulations to be used to produce the one or more formulated lubricants for optimizing LVC profit, subject to availability of one or more components, and considering incentives and constraints.

Element 10: wherein a bias is calculated for one or more properties of optimized recipes subject to Equation 1:

$$ln ( {Bias}_{i} ) = ln {v}_{i} - {\sum }_{j} ( ln {u}_{j} ) {w}_{j} \qquad ( Equation 1 )$$

wherein:
   Bias is bias calculated for property i
   vᵢ is a blended recipe calibration value for property i
   wⱼ is a calibration weight percent of component j in a calibration blend
   uⱼ is a neat property value for component j.

Element 11: wherein the plurality of data includes one or more lubricant properties selected from the group consisting of kinematic viscosity, cold cranking viscosity, Noack volatility, and any combination thereof.

Element 12: wherein the one or more lubricant properties are modeled in a linear or log-linear fashion.

Element 13: wherein processing the one or more filtered scenarios leverages a calibration blend to estimate any impact of components for which no property data is available.

Element 14: wherein the method further comprises producing the calibration blend.

Element 15: wherein one or more of the formulated lubricants are blended in a staged process, wherein components of the formulated lubricants are mixed together as one or more premixes prior to being incorporated together to form a formulated lubricant.

Element 16: wherein the one or more premixes comprise a blend of one or more precursor premixes.

Element 17: wherein the optimization engine is cloud-based.

By way of non-limiting example, exemplary combinations applicable to A-C include, but are not limited to: 1 and 2; 1 and 3; 1-3; 1 and 4; 1-4; 1, 2 and 4; 1, 3 and 4; 1 and 5; 1-5; 1, 2, and 5; 1, 3 and 5; 1, 4 and 5; 1 and 6; 1-6; 1, 2 and 6; 1, 3 and 6; 1, 4 and 6; 1, 5 and 6; 1 and 7; 1-7; 1, 2 and 7; 1, 3 and 7; 1, 4 and 7; 1, 5 and 7; 1, 6 and 7; 1 and 8; 1-8; 1, 2 and 8; 1, 3, and 8; 1, 4 and 8; 1, 5 and 8; 1, 6 and 8; 1, 7 and 8; 1 and 9; 1-9; 1, 2 and 9; 1, 3 and 9; 1, 4 and 9; 1, 5 and 9; 1, 6 and 9; 1, 7 and 9; 1, 8 and 9; 1 and 10; 1-10; 1, 2, and 10; 1, 3 and 10; 1, 4 and 10; 1, 5 and 10; 1, 6 and 10; 1, 7 and 10; 1, 8 and 10; 1, 9 and 10; 1 and 11; 1-11; 1, 2 and 11; 1, 3 and 11; 1, 4 and 11; 1, 5 and 11; 1, 6 and 11; 1, 7 and 11; 1, 8 and 11; 1, 9 and 11; 1, 10 and 11; 1, 11 and 12; 1-12; 1, 2, 11 and 12; 1, 3, 11 and 12; 1, 4, 11 and 12; 1, 5, 11 and 12; 1, 6, 11 and 12; 1, 7, 11 and 12; 1, 8, 11 and 12; 1, 9, 11 and 12; 1, 10, 11 and 12; 1 and 13; 1-13; 1, 2, 11 and/or 13; 1, 3, 11 and/or 13; 1, 4, 11 and/or 13; 1, 5, 11 and/or 13; 1, 6, 11 and/or 13; 1, 7, 11 and/or 13; 1, 8, 11 and/or 13; 1, 9, 11 and/or 13; 1, 10, 11 and/or 13; 1-14; 1, 2, 13 and 14; 1, 3, 13 and 14; 1, 4, 13 and 14; 1, 5, 13 and 14; 1, 6, 13 and 14; 1, 7, 13 and 14; 1, 8, 13 and 14; 1, 9, 13 and 14; 1, 10, 13 and 14; 1 and 15; 1-11 and 15; 1-11, 13 and 15; 1, 2 and 15; 1, 3 and 15; 1, 4 and 15; 1, 5 and 15; 1, 6 and 15; 1, 7 and 15; 1, 8 and 15; 1, 9 and 15; 1, 10 and 15; 1, 15 and 16; 1-11, 15 and 16; 1-11, 13, 15 and 16; 1, 2 and 15; 1, 3, 15 and 16; 1, 4, 15 and 16; 1, 5, 15 and 16; 1, 6, 15 and 16; 1, 7, 15 and 16; 1, 8, 15 and 16; 1, 9, 15 and 16; 1, 10, 15 and 16; 2 and 3; 2 and 4; 2-4; 2, 3 and 4; 2 and 5; 2-5; 2, 3 and 5; 2, 4 and 5; 2 and 6; 2-6; 2, 3 and 6; 2, 4 and 6; 2, 5 and 6; 2 and 7; 2-7; 2, 3 and 7; 2, 4 and 7; 2, 5 and 7; 2, 6 and 7; 2 and 8; 2, 3 and 8; 2, 4 and 8; 2, 5 and 8; 2, 6 and 8; 2, 7 and 8; 2 and 9; 2-9; 2, 3 and 9; 2, 4 and 9; 2, 5 and 9; 2, 6 and 9; 2, 7 and 9; 2, 8 and 9; 2 and 10; 2-10; 2, 3 and 10; 2, 4 and 10; 2, 5 and 10; 2, 6 and 10; 2, 7 and 10; 2, 8 and 10; 2, 9 and 10; 2 and 11; 2-11; 2, 3 and 11; 2, 4 and 11; 2, 5 and 11; 2, 6 and 11; 2, 7 and 11; 2, 8 and 11; 2, 9 and 11; 2, 10 and 11; 2, 11 and 12; 2-12; 2, 11 and 12; 2, 3, 11 and 12; 2, 4, 11 and 12; 2, 5, 11 and 12; 2, 6, 11 and 12; 2, 7, 11 and 12; 2, 8, 11 and 12; 2, 9, 11 and 12; 2, 10, 11 and 12; 2 and 13; 2-13; 2, 3, 11 and/or 13; 2, 4, 11 and/or 13; 2, 5, 11 and/or 13; 2, 6, 11 and/or 13; 2, 7, 11 and/or 13; 2, 8, 11 and/or 13; 2, 9, 11 and/or 13; 2, 10, 11 and/or 13; 2-14; 2, 13 and 14; 2, 13 and 14; 2, 4, 13 and 14; 2, 5, 13 and 14; 2, 6, 13 and 14; 2, 7, 13 and 14; 2, 8, 13 and 14; 2, 9, 13 and 14; 2, 10, 13 and 14; 2 and 15; 2-11 and 15; 2-11, 13 and 15; 2, 3 and 15; 2, 4 and 15; 2, 5 and 15; 2, 6 and 15; 2, 7 and 15; 2, 8 and 15; 2, 9 and 15; 2, 10 and 15; 2, 15 and 16; 2-11, 15 and 16; 2-11, 13, 15 and 16; 2, 3 and 15; 2, 3, 15 and 16; 2, 4, 15 and 16; 2, 5, 15 and 16; 2, 6, 15 and 16; 2, 7, 15 and 16; 2, 8, 15 and 16; 2, 9, 15 and 16; 2, 10, 15 and 16; 3 and 4; 3 and 5; 3-5; 3, 4 and 5; 3 and 6; 3-6; 3, 4 and 6; 3, 5 and 6; 3 and 7; 3-7; 3, 4 and 7; 3, 5 and 7; 3, 6 and 7; 3 and 8; 3, 4 and 8; 3, 5 and 8; 3, 6 and 8; 3, 7 and 8; 3 and 9; 3-9; 3, 4 and 9; 3, 5 and 9; 3, 6 and 9; 3, 7 and 9; 3, 8 and 9; 3 and 10; 3-10; 3, 4 and 10; 3, 5 and 10; 3, 6 and 10; 3, 7 and 10; 3, 8 and 10; 3, 9 and 10; 3 and 11; 3-11; 3, 4 and 11; 3, 5 and 11; 3, 6 and 11; 3, 7 and 11; 3, 8 and 11; 3, 9 and 11; 3, 10 and 11; 3, 11 and 12; 3-12; 3, 11 and 12; 3, 4, 11 and 12; 3, 5, 11 and 12; 3, 6, 11 and 12; 3, 7, 11 and 12; 3, 8, 11 and 12; 3, 9, 11 and 12; 3, 10, 11 and 12; 3 and 13; 2-13; 3, 11 and/or 13; 3, 4, 11 and/or 13; 3, 5, 11 and/or 13; 3, 6, 11 and/or 13; 3, 7, 11 and/or 13; 3, 8, 11 and/or 13; 3, 9, 11 and/or 13; 3, 10, 11 and/or 13; 3-14; 3, 13 and 14; 3, 13 and 14; 3, 4, 13 and 14; 3, 5, 13 and 14; 3, 6, 13 and 14; 3, 7, 13 and 14; 3, 8, 13 and 14; 3, 9, 13 and 14; 3, 10, 13 and 14; 3 and 15; 3-11 and 15; 3-11, 13 and 15; 3, 4 and 15; 3, 5 and 15; 3, 6 and 15; 3, 7 and 15; 3, 8 and 15; 3, 9 and 15; 3, 10 and 15; 3, 15 and 16; 3-11, 15 and 16; 3-11, 13, 15 and 16; 3, 15 and 16; 3, 4, 15 and 16; 3, 5, 15 and 16; 3, 6, 15 and 16; 3, 7, 15 and 16; 3, 8, 15 and 16; 3, 9, 15 and 16; 3, 10, 15 and 16; 4 and 5; 4 and 6; 4-6; 4, 5 and 6; 4 and 7; 4-7; 3, 4, 5 and 7; 4, 6 and 7; 4 and 8; 4, 5 and 8; 4, 6 and 8; 4, 7 and 8; 4 and 9; 4-9; 4, 5 and 9; 4, 6 and 9; 4, 7 and 9; 4, 8 and 9; 4 and 10; 4-10; 4, 5 and 10; 4, 6 and 10; 4, 7 and 10; 4, 8 and 10; 4, 9 and 10; 4 and 11; 4-11; 4, 5 and 11; 4, 6 and 11; 4, 7 and 11; 4, 8 and 11; 4, 9 and 11; 4, 10 and 11; 4, 11 and 12; 4-12; 4, 11 and 12; 4, 5, 11 and 12; 4, 6, 11 and 12; 4, 7, 11 and 12; 4, 8, 11 and 12; 4, 9, 11 and 12; 4, 10, 11 and 12; 4 and 13; 4-13; 4, 11 and/or 13; 4, 5, 11 and/or 13; 4, 6, 11 and/or 13; 4, 7, 11 and/or 13; 4, 8, 11 and/or 13; 4, 9, 11 and/or 13; 4, 10, 11 and/or 13; 4-14; 4, 13 and 14; 4, 5, 13 and 14; 4, 6, 13 and 14; 4, 7, 13 and 14; 4, 8, 13 and 14; 4, 9, 13 and 14; 4, 10, 13 and 14; 4 and 15; 4-11 and 15; 4-11, 13 and 15; 4 and 15; 4, 6 and 15; 4, 7 and 15; 4, 8 and 15; 4, 9 and 15; 4, 10 and 15; 4, 15 and 16; 4-11, 15 and 16; 4-11, 13, 15 and 16; 4, 15 and 16; 4, 5, 15 and 16; 4, 6, 15 and 16; 4, 7, 15 and 16; 4, 8, 15 and 16; 4, 9, 15 and 16; 4, 10, 15 and 16; 5 and 6; 5 and 7; 5-7; 5, 6 and 7; 5 and 8; 5, 6 and 8; 5, 7 and 8; 5 and 9; 5-9; 5, 6 and 9; 5, 7 and 9; 5, 8 and 9; 5 and 10; 5-10; 5, 6 and 10; 5, 7 and 10; 5, 8 and 10; 5, 9 and 10; 5 and 11; 5-11; 5, 6 and 11; 5, 7 and 11; 5, 8 and 11; 5, 9 and 11; 5, 10 and 11; 5, 11 and 12; 5-12; 5, 11 and 12; 5, 6, 11 and 12; 5, 7, 11 and 12; 5, 8, 11 and 12; 5, 9, 11 and 12; 5, 10, 11 and 12; 5 and 13; 5-13; 5, 11 and/or 13; 5, 6, 11 and/or 13; 5, 7, 11 and/or 13; 5, 8, 11 and/or 13; 5, 9, 11 and/or 13; 5, 10, 11 and/or 13; 5-14; 5, 13 and 14; 5, 6, 13 and 14; 5, 7, 13 and 14; 5, 8, 13 and 14; 5, 9, 13 and 14; 5, 10, 13 and 14; 5 and 15; 5-11 and 15; 5-11, 13 and 15; 5 and 15; 5, 6 and 15; 5, 7 and 15; 5, 8 and 15; 5, 9 and 15; 5, 10 and 15; 5, 15 and 16; 5-11, 15 and 16; 5-11, 13, 15 and 16; 5, 15 and 16; 5, 6, 15 and 16; 5, 7, 15 and 16; 5, 8, 15 and 16; 5, 9, 15 and 16; 5, 10, 15 and 16; 6 and 7; 6 and 8; 6, 7 and 8; 6 and 9; 6-9; 6, 7 and 9; 6, 8 and 9; 6 and 10; 6-10; 6, 7 and 10; 6, 8 and 10; 6, 9 and 10; 6 and 11; 6-11; 6, 7 and 11; 6, 8 and 11; 6, 9 and 11; 6, 10 and 11; 6, 11 and 12; 6-12; 6, 7, 11 and 12; 6, 8, 11 and 12; 6, 9, 11 and 12; 6, 10, 11 and 12; 6 and 13; 6-13; 6, 11 and/or 13; 6, 7, 11 and/or 13; 6, 8, 11 and/or 13; 6, 9, 11 and/or 13; 6, 10, 11 and/or 13; 6-14; 6, 13 and 14; 6, 7, 13 and 14; 6, 8, 13 and 14; 6, 9, 13 and 14; 6, 10, 13 and 14; 6 and 15; 6-11 and 15; 6-11, 13 and 15; 6 and 15; 6, 7 and 15; 6, 8 and 15; 6, 9 and 15; 6, 10 and 15; 6, 15 and 16; 6-11, 15 and 16; 6-11, 13, 15 and 16; 6, 15 and 16; 6, 7, 15 and 16; 6, 8, 15 and 16; 6, 9, 15 and 16; 6, 10, 15 and 16; 8 and 9; 8 and 10; 8-10; 8 and 11; 8-11; 8, 9 and 11; 8, 10 and 11; 8, 11 and 12; 8-12; 8, 9, 11 and 12; 8, 10, 11 and 12; 8 and 13; 8-13; 8, 11 and/or 13; 8, 9, 11 and/or 13; 8, 10, 11 and/or 13; 8-14; 8, 13 and 14; 8, 9, 13 and 14; 8, 10, 13 and 14; 8 and 15; 8-11 and 15; 8-11, 13 and 15; 8, 9 and 15; 8, 10 and 15; 8, 15 and 16; 8-11, 15 and 16; 8-11, 13, 15 and 16; 8, 9, 15 and 16; 8, 10, 15 and 16; 9 and 10; 9 and 11; 9-11; 9, 10 and 11; 9, 11 and 12; 9-12; 9 and 13; 9-13; 9, 11 and/or 13; 9, 10, 11 and/or 13; 9-14; 9, 13 and 14; 9, 10, 13 and 14; 9 and 15; 9-11 and 15; 9-11, 13 and 15; 9, 10 and 15; 9, 15 and 16; 9-11, 15 and 16; 9-11, 13, 15 and 16; 9, 10, 15 and 16; 10 and 11; 10, 11 and 12; 9-12; 10 and 13; 10-13; 10, 11 and/or 13; 10-14; 10, 13 and 14; 10, 13 and 14; 10 and 15; 10, 11 and 15; 10, 11, 13 and 15; 10 and 15; 10, 15 and 16; 10, 11, 15 and 16; 10, 11, 13, 15 and 16; 11 and 12; 11 and 13; 11-13; 11-14; 11, 13 and 14; 11 and 15; 11, 13 and 15; 11, 15 and 16; 11, 13, 15 and 16; 11, 12 and 15; 11-13 and 15; 11, 12, 15 and 16; 11-13, 15 and 16; 13 and 14; 11, 13 and 15; 13-15; 13, 15 and 16; 13-16; and 15 and 16.

To facilitate a better understanding of the embodiments of the present disclosure, the following examples of preferred or representative embodiments are given. In no way should the following examples be read to limit, or to define, the scope of the invention.

### EXAMPLES

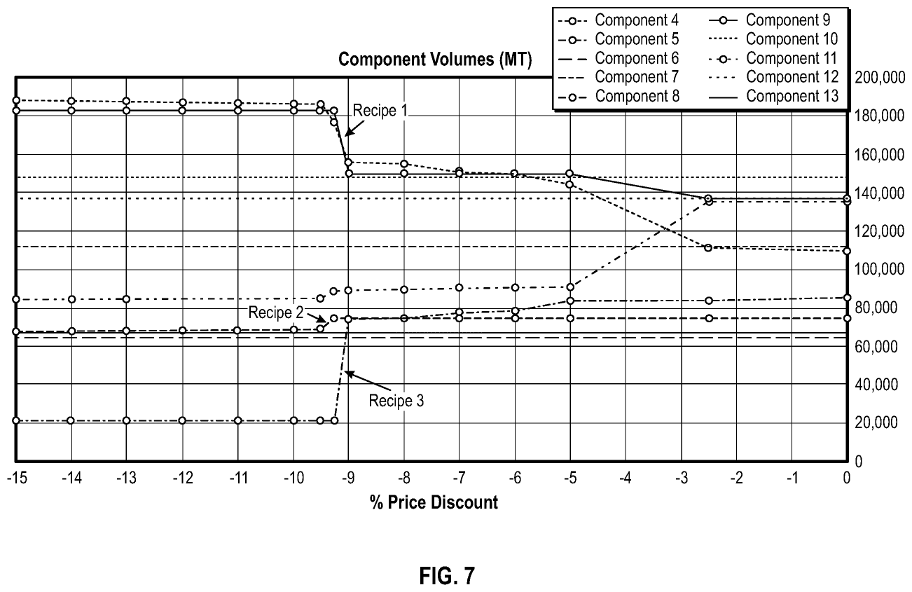

FIG. 7 is an illustrative plot demonstrating how LVCO may be used to determine the optimal component volumes under a range of price scenarios for a specified set of recipes. Along the horizontal axis, the cost of basestock Component 4 decreases from right to left (as expressed as a percentage). The optimal volume of other components used in the LVC recipes at each price point are plotted on the vertical access. Changes in component volumes occur due to changes in optimal production recipes as the price of basestock Component 4 is reduced. Among other applications, these results may be used in procurement negotiations to determine the anticipated purchase volume of components at different agreed prices. This analysis may be completed with LVCO by solving scenarios under a range of price inputs.

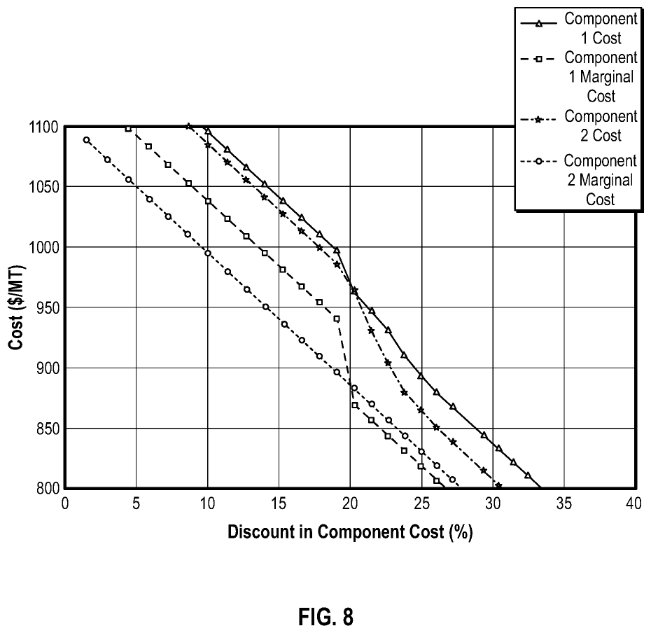

FIG. 8 is an illustrative plot of how component costs may by varied across a set of sensitivity analysis cases when optimizing a LVC. In this example, a set of scenarios were generated by varying price inputs across a predetermined range. Component costs and their corresponding marginal costs are graphed on the vertical axis.

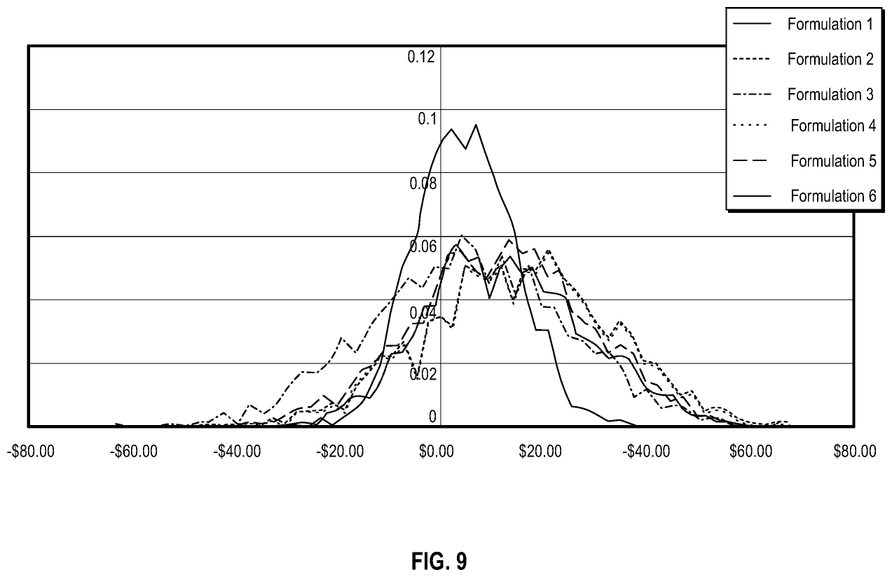

FIG. 9 is an illustrative plot of Monte Carlo case results for the expected LVC value of various new lubricant formulations (Formulations 1-6), which may include different components and treat rates, in comparison to baseline. The plot are a histograms of additional LVC value contributed by a set of new product formulations. The additional LVC value (as compared to a baseline including only current recipe options) is graphed on the horizontal axis. Frequency is graphed on the vertical axis. This plot may be created by compiling the results of two thousand scenarios with randomly generated price inputs. The values used in each scenario are randomly selected from price distributions, as based on a statistical analysis of component price history. The expected LVC value of new recipe options may be determined by finding the average additional LVC calculated in each scenario.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the lower limit and upper limit. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A computer-implemented method for optimizing a lubricants value chain (LVC), the method comprising:
providing a plurality of data representative of a LVC and a plurality of hypothetical inputs representative of changes to the plurality of data into an isolated data processing environment;
converting the plurality of data into one or more scenarios based upon the plurality of hypothetical inputs in the isolated data processing environment;
filtering the one or more scenarios based upon one or more properties thereof to create one or more filtered scenarios;
processing the one or more filtered scenarios to generate one or more optimized scenarios using a two-stage optimization algorithm in which first and second stages of the two-stage optimization algorithm are conducted in sequence and separately from each other, the first stage of the two-stage optimization algorithm comprising recipe optimization and the second stage of the two-stage optimization algorithm comprising value chain optimization; and
determining from the one or more optimized scenarios one or more outputs that optimize profit within the LVC by determining optimal recipe selections for one or more formulated lubricants and supply layer allocations.

2. The method of claim 1, wherein the plurality of data includes a plurality of lubricant characteristics and recipes applicable to a plurality of formulated lubricants.

3. The method of claim 1, wherein the one or more scenarios are based upon one or more applications selected from the group consisting of treat rates; make versus buy; short and/or long component availability; supply layers; Business Continuity Planning (BCP) response including recipe and production changes; investment scoping; development formulation scoping including assessed impact of development formulations; formulation flexibility assessment; recipe optimization; incentives; constraints; production plan; component properties; production scoping; production planning; Request for Quotation (RFQ) analysis; customer profitability; procurement planning and supplier negotiations; break even analysis; hypothetical inputs; parametric studies and sensitivity analysis; Monte Carlo simulation including price, volume, and parameter uncertainty; and any combination thereof.

4. The method of claim 1, wherein recipe optimization applies one or more of the following parameters to a recipe: component selection and availability, treat rate flexibility comprising minimum and maximum treat rates, premix selection, and implementation characteristics.

5. The method of claim 1, wherein processing the one or more filtered scenarios comprises:
solving the one or more scenarios using one or more mathematical models;
saving an optimal solution for the one or more scenarios;
calculating a recipe cost based on one or more optimized treat rates;
calculating a bias for each property during recipe optimization;
updating a premix component cost during recipe optimization; and
estimating costs for any unavailable components.

6. The method of claim 1, wherein the two-stage optimization algorithm defines a linear programming model.

7. The method of claim 1, wherein the two-stage optimization algorithm comprises a first type of mathematical model and a second type of mathematical model.

8. The method of claim 7, wherein the first type of mathematical model and the second type of mathematical model are developed as mixed integer linear programming problems.

9. The method of claim 1, wherein recipe optimization includes at least treat rate optimization.

10. The method of claim 1, wherein the two-stage optimization algorithm determines one or more specific formulations to be used to produce the one or more formulated lubricants for optimizing LVC profit, subject to availability of one or more components, and considering incentives and constraints.

11. The method of claim 1, wherein a bias is calculated for one or more properties of optimized recipes subject to Equation 1:
$$ln ( {Bias}_{i} ) = ln {v}_{i} - {\sum }_{j} ( ln {u}_{j} ) {w}_{j} \qquad ( Equation 1 )$$
wherein:
Bias is bias calculated for property i
vᵢ is a blended recipe calibration value for property i
wⱼ is a calibration weight percent of component j in a calibration blend
uⱼ is a neat property value for component j.

12. The method of claim 1 wherein the plurality of data includes one or more lubricant properties selected from the group consisting of kinematic viscosity, cold cranking viscosity, Noack volatility, and any combination thereof.

13. The method of claim 12, wherein the one or more lubricant properties are modeled in a linear or log-linear fashion.

14. The method of claim 1, wherein processing the one or more filtered scenarios leverages a calibration blend to estimate any impact of components for which no property data is available.

15. The method of claim 14, further comprising:
producing the calibration blend.

16. The method of claim 1, wherein one or more of the formulated lubricants are blended in a staged process, wherein components of the formulated lubricants are mixed together as one or more premixes prior to being incorporated together to form a formulated lubricant.

17. The method of claim 16, wherein the one or more premixes comprise a blend of one or more precursor premixes.

18. A system configured to carry out a computer-implemented method for optimizing a lubricants value chain (LVC), the method comprising:
providing a plurality of data representative of a LVC and a plurality of hypothetical inputs representative of changes to the plurality of data into an isolated data processing environment;
converting the plurality of data into one or more scenarios based upon the plurality of hypothetical inputs in the isolated data processing environment;
filtering the one or more scenarios based upon one or more properties thereof to create one or more filtered scenarios;
processing the one or more filtered scenarios to generate one or more optimized scenarios using a two-stage optimization algorithm in which first and second stages of the two-stage optimization algorithm are conducted in sequence and separately from each other, the first stage of the two-stage optimization algorithm comprising recipe optimization and the second stage of the two-stage optimization algorithm comprising value chain optimization; and
determining from the one or more optimized scenarios one or more outputs that optimize profit within the LVC by determining optimal recipe selections for one or more formulated lubricants and supply layer allocations;
the system comprising:
a computing device comprising:
a processor;
a memory coupled to the processor;
an isolated data processing environment;
an optimization engine; and
instructions provided to or stored in the memory, wherein the instructions are executable by the processor to optimize a lubricants value chain according to the computer-implemented method for optimizing a lubricants value chain (LVC).

19. The system of claim 18, wherein the optimization engine is cloud-based.

20. A computing device comprising instructions which, when executed by a processor, cause the processor to optimize a lubricants value chain according to a computer-implemented method for optimizing a lubricants value chain (LVC), the method comprising:
providing a plurality of data representative of a LVC and a plurality of hypothetical inputs representative of changes to the plurality of data into an isolated data processing environment;
converting the plurality of data into one or more scenarios based upon the plurality of hypothetical inputs in the isolated data processing environment;
filtering the one or more scenarios based upon one or more properties thereof to create one or more filtered scenarios;
processing the one or more filtered scenarios to generate one or more optimized scenarios using a two-stage optimization algorithm in which first and second stages of the two-stage optimization algorithm are conducted in sequence and separately from each other, the first stage of the two-stage optimization algorithm comprising recipe optimization and the second stage of the two-stage optimization algorithm comprising value chain optimization; and
determining from the one or more optimized scenarios one or more outputs that optimize profit within the LVC by determining optimal recipe selections for one or more formulated lubricants and supply layer allocations.
